(19) United States
(12) Patent Application Publication
(10) Pub. No.: US 2004/0133586 A1
(43) Pub. Date: Jul. 8, 2004

(54) Information point with vertical screen displacement

(76) Inventor: Antonio Manuel Ceballos Counago, Madrid (ES)

Correspondence Address: Jose Antonio Urizar Anasagasti, Victor De La Serna 3 5 Parking, Madrid, 28016, ES

(21) Appl. No.: 10/432,779

(22) PCT Filed: Nov. 27, 2001
(86) PCT No.: PCT/ES01/00461

(30) Foreign Application Priority Data
Nov. 27, 2000 (ES) 200002836

(51) Int. Cl. G06F 7/00

(52) U.S. Cl. 707/102

(57) ABSTRACT

The ergonomic thematic tourist information point is related to an information centre or point, which provides users with thematic-tourist information and is ergonomic, by way of situating these interactive terminals connected to a network in strategic locations, with all information of any kind, and with the characteristics of a “universal interface”, which includes vertical screen movement as well as the possibility of comfortable access for all sorts of persons, of different heights, age, and physical disability, generating a service accessible to any kind of persons that come to receive information. It is provided with a computer system that can store, provide, give information, as well as transmit information from the computer point to another receiver. The computer system includes height and presence sensors, as well as a system for holding it to the ground by way of air pressure.

### OBJECT OF THE INVENTION

The object of the present invention patent, as shown by the title of this description, is related to an ergonomic thematic tourist information point or centre, by situating interactive terminals connected by network in strategic positions, with all information of any kind, and with the characteristics of a “universal interface”, as well as vertical screen movement, which includes the possibility of easy access for all sorts of people, of different height, age and physical disabilities, generating an accessible service to any kind of persons who may come to receive information.

The present invention includes the option of incorporating a computer system that can save and provide any kind of information, as well as sending information or messages from the information point to any other receiver. Where any user may leave a message for another person, as well as sending an e-mail message, etc.

This strategic information point can be used as a thematic tourist item at strategic locations, streets, squares, lounges, conventions, public institutions, companies, hotels, etc.

As well as a buying-selling point for products and/or services, catalogue support, etc.

Parts and Physical Support that Make Up the Thematic Ergonomic Tourist Information Point

Screen with tactile feature and automatic movement, as well as the choice of being manual.

Vertical mobile elements or support guides which facilitate vertical movement of the screen, as well as manual adjustment of the height of the screen in direct proportion to the height of the person that is going to receive information.

The design of the support structure is innovative and has no barriers for persons with any disability.

Height and presence sensors.

Self-cooling housing for the computer, control and security system.

System for anchoring to floor by way of air pressure, attached to the metal structure.

The information point assembly and support is provided with a mirror, located on its upper concave area, as an eye-catcher and distance visibility provider.

### BACKGROUND OF THE INVENTION

At present a variety of information points or machines with similar content are on the market, but they do not provide for certain ergonomic matters, such as the different heights of the users (from short persons to very tall ones), who need screens that are adjusted to people's height, in order to see and operate them comfortably, as well as disabled persons access (in wheelchairs), who generally cannot gain access to seeing the screen or encounter frames or other barriers which prevent them from approaching the information point machine. The blind, who cannot access information unless the system avails of a voice processor, etc. In order to solve this access problem for the disabled, low height machines have been created, which seem to be specifically designed for the disabled, but which are not operable by normal or very tall persons.

On the other hand, the existing machines are not connected to a central network from which information can be updated or modified, without technical assistance by a technician at each information point, but rather consist of a portable computer on a pedestal with a tactile screen (much more expensive to install and maintain).

From the point of view of holding them to the ground, the anchoring elements of these machines normally damage it, or else, in absence of authorisation from the owner of the land, approval must be sought from other sources.

Among the machines of this kind on the market, some lack printing elements, and those that do have them, as well as increasing costs, have the drawback of lacking paper in many cases.

At the information points presently on the market, a one-piece tactile screen, as a single element, is normally installed, which makes the product more expensive when due to usage or breakdown the tactile element must be replaced.

From the orientation analysis for establishing and comparing the invention with the state of the art, some of the innovations of the sector for this sort of information are listed below.

An analysis of the competition has been carried out, by way of search on an information media such as the Internet.

The motivations for using the world wide web as a comparative instrument is a logical conclusion, these kiosks or information points are the development of new technology, and thus they should be present on the Internet.

In this analysis of the competition, we offer some comments on companies that produce the same information but which do not avail of the innovations provided by our invention.

Touchscreens company, of the U.S.A., is one of the biggest companies in the world for tactile screens, information points or interactive kiosks, and are not adapted to disabled persons.

NCR Company produces models including a portable computer, with a stand and tactile screen, oriented to buying in supermarket areas.

The models found in Spain, and especially those located in official institutions, do not provide an optimal viewing angle, nor an independent computer system, are not connected to a network, nor are they appropriate for disabled persons, since they include a step which is a barrier for the disabled. Guides are included on them, which do not have the function of screen movement but rather allow a printing element to be attached.

Model TK400, in spite of its design, is nevertheless static and rigid, and the lower bar is a barrier for the disabled.

### DESCRIPTION OF THE INVENTION

Ergonomic thematic tourist information point, which offers information to users located in strategic areas of interactive terminals connected to networks with all information of any kind, and with the characteristics of “universal interface”, as well as vertical screen movement, making it the innovation in mobile screens, which includes the possibility of comfortable access for all sorts of persons, ages and physical disabilities, generating an accessible service for any type of person who may come to receive information.

The presence of two “sensors”. A presence sensor or alarm, for offering attention to the persons who approach the information point within a detectable area (it measures electrical differences in the atmosphere) to detect and immediately activate an alarm mechanism or presence by sound or voice, inviting the user to approach and use the information point. The other sensor, which automatically measures the height of the person once they have approached the machine and situates the mobile screen, by vertical movement on the lateral guides, at the appropriate height for the user, whether it be normal, lower, higher, disabled in wheelchair, or any other physical handicap, etc.

This information point lacks steps and barriers which encourages disabled, wheelchair users and the like to approach it.

The innovation of the “mobile screen” allows for the adjustment of its height by way of vertical (pneumatic) mobility elements, automatically once the height sensor is activated, or even alternatively in a manual mode, in case the sensor may not be functioning. To this effect, the screen is provided with a structure or design in the shape of a handle on its lower edge, for manual holding and pushing.

The mobile screen can be made up of two parts and physical components, a solid metal structure, within which the tactile monitor is introduced and a plastic, (recyclable) injectable one, so that the screen is separate from the tactile element in order to reduce costs. It will suffer breakdown before the screen itself does, therefore only the tactile element need be replaced, since in the state of the art, the installation of a whole tactile screen is necessary on the market, which increases repair or substitution costs enormously in case of breakdown.

The incorporation of a voice computer system for the blind and other physical disabilities that do not permit the use of the tactile screen.

The information is controlled and depends on a network or Intranet connection, and from a central hub it can be updated or changed without the need for a technician to go to each of the information points to manipulate the machine (maintenance and information costs decrease, as well as simultaneous working and coordination at all of the information points).

A reflecting element (mirror) is included on the upper part of the machine, which works as a display and long-distance information (from a distance, the user can obtain information on the services the machine offers without approaching it, even if other persons are using it), as well as an eye-catching element, since the screen can be seen at a distance.

It includes a hidden system for anchoring it to the floor by air pressure, attached to the metal structure, which is preferably located on the lower back area within a metal structure which is accessed with a key, or a key and a code, as a security and control system reserved for use by authorised technicians only. Most of these machines have the drawback that they can be taken if they cannot be anchored to the ground, either due to damage that would occur to the ground itself, or due to the lack of permission from the owners of the place it is located in, or else because the anchoring elements are visible and can be manipulated. In order to prevent possible robbery and floor damage, the invention includes an innovative hidden anchoring and security system by way of installing air pressure elements (suction cups like those used for holding large sheets of glass) which remains hidden from the users, on its own structure and away from any possible manipulation (it works by vacuum absorption, automatically and optionally manually in case of lack of electrical current), being a simple an low-cost pneumatic system.

The invention carries out a reading and printing support, although it does not include a printer nor paper (since this would increase breakdown possibilities, permanent technical assistance for supplying paper, as well as user discomfort when paper is lacking as they cannot take away the printed information obtained). In the present invention, printing documents or information is carried out on UAP or UMTS (on mobile phones), so that the user can take information away on their own mobile phone, without needing to transport nor carry awkward pieces of paper, in accordance with the demands of tourists or visitors that obtain information at the point on the city or place being visited.

In order to complete the description that will be presented below, and to provide an improved understanding of the characteristics of the invention, the present account is accompanied by diagrams through whose figures the innovations and advantages of the protection of the object of the invention can be better understood.

### BRIEF DESCRIPTION OF THE DRAWINGS

FIG. 1 show a perspective view of the ergonomic thematic tourist information point.

FIG. 2 shows a perspective conic projection view, showing in position (A) the height and presence sensors that facilitate vertical screen movement, and in position (B) the self-cooling housing for the control and security computer system, where the tactile screen has automatic vertical movement that is adapted by a sensor to the height of the user.

FIG. 3 shows a front view of the ergonomic thematic tourist information point, where the person that is receiving information is located, as well as the mirror located on the upper concave area of the support structure, which serves as an distance visibility provider and eye-catcher.

FIG. 4 shows a top and profile view of the support structure of the ergonomic thematic tourist information point.

FIG. 5 shows the plane positioning of the support structure of the ergonomic thematic tourist information point.

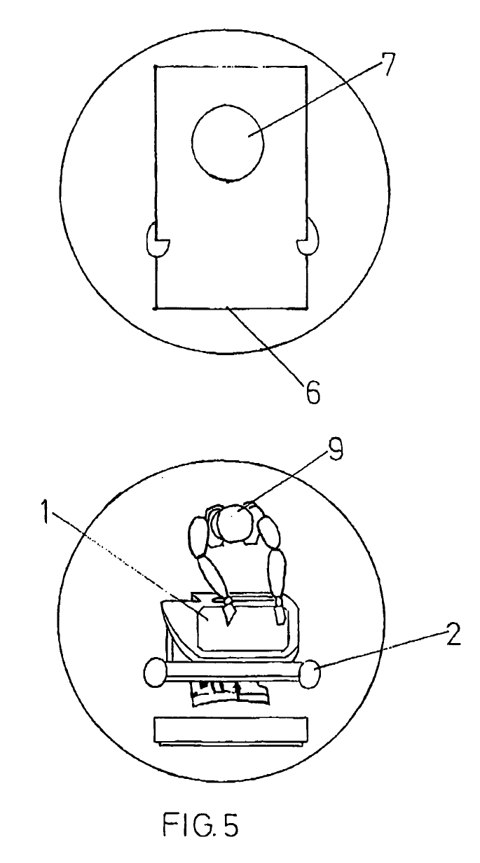

FIG. 6 shows the anchoring system, where the air pressure elements attached to the metal structure are indicated.

### PREFERRED EMBODIMENT OF THE INVENTION

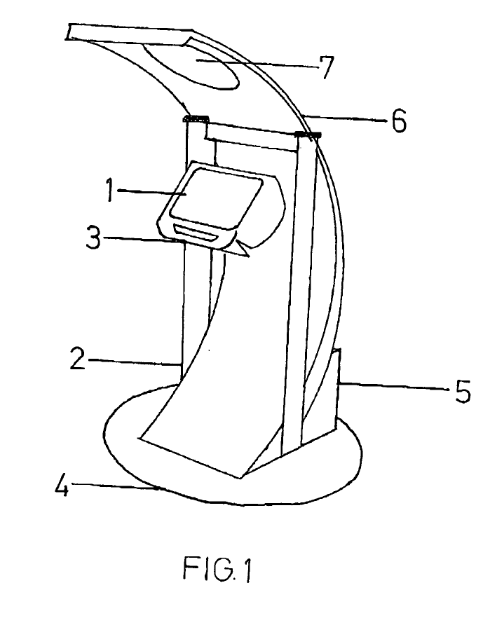

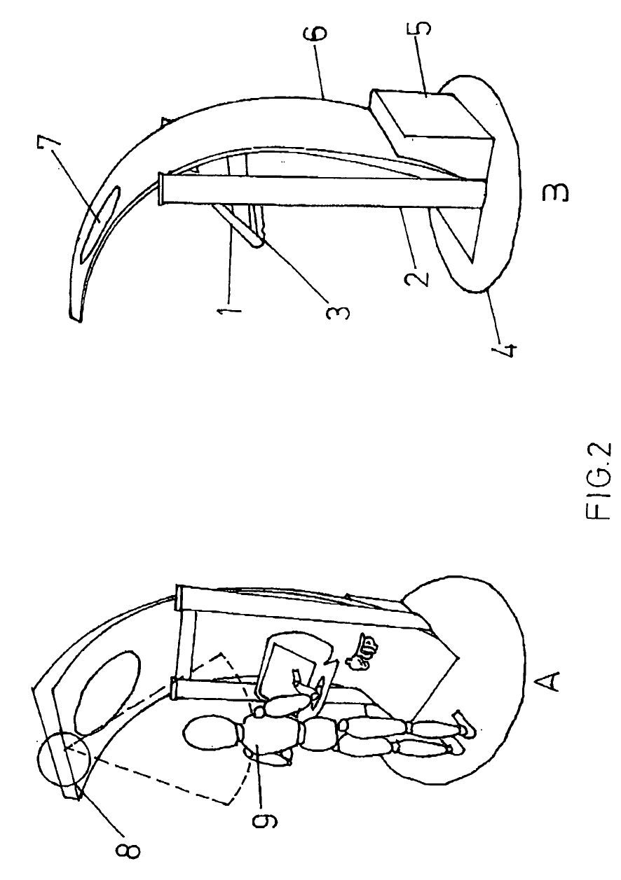

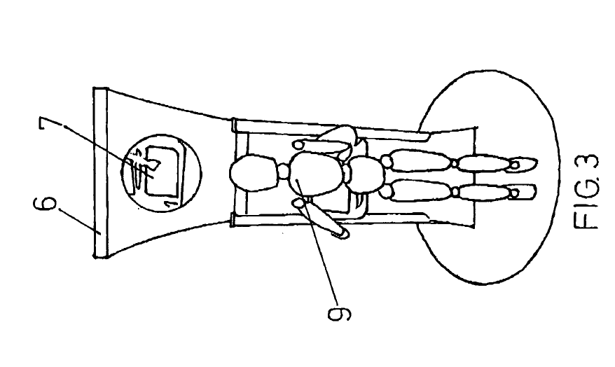

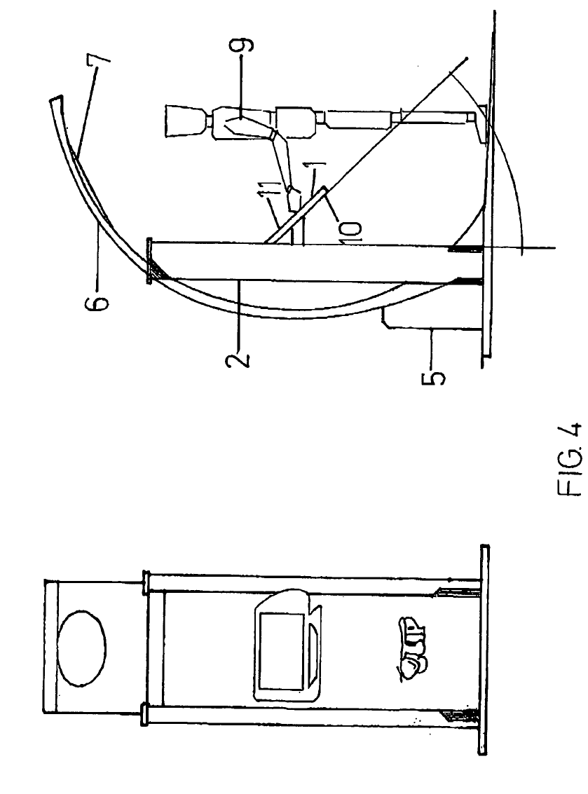

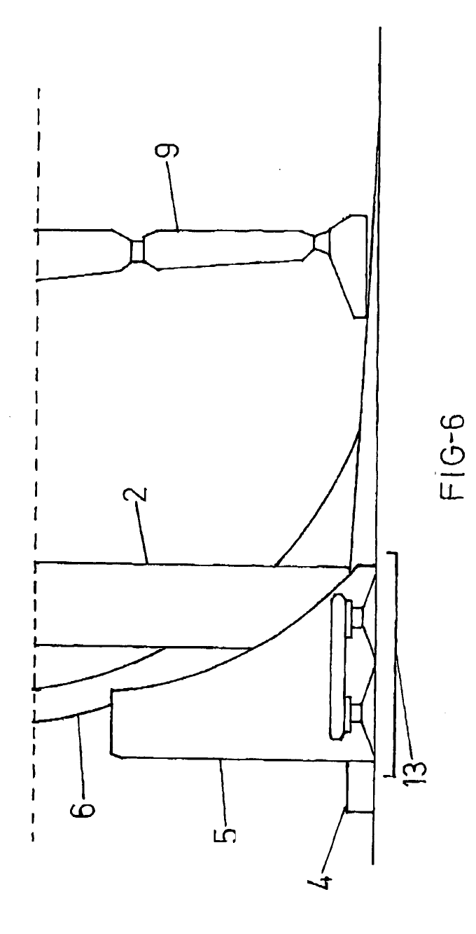

The present preferred practical embodiment of the invention, the ergonomic thematic tourist information point, consists of the mobile screen as shown in FIG. 1 and in FIG. 4, where the screen positioning (1), and user position (9) are shown in front of the tactile element which has the plastic covering (11), the whole assembly carrying out automatic vertical movement. The general inner structure is consolidated by support guide columns (2), which facilitate the sliding of the display screen assembly. The screen (1) on its salient part, includes a handle (3) as shown in FIG. 2. The arched or concave structure (6) is sustained by the support base (4), being attached to the ground, see FIG. 1. On the support base of the structure, the structure which houses the self-cooling equipment for the control and security computer system as shown in FIGS. 1 and 2, position (B). On the arched or concave support (6) of the structure of the information point, and on its upper area, a mirror (7) is lodged, see FIGS. 1 and 3, being a distance visibility provider and eye-catcher. On the upper salient part of the arched structure (6), the sensors (8) are located, as shown in FIG. 2, position (A), the function of which is to determine the height of the user as well as their presence. The user position (9) before the mobile screen, once the sensors have worked as shown in FIG. 2 position (A) and FIGS. 3 and 4. The screen (1) is protected by a plastic upper covering (11) and a metal lower covering (10), shown in FIG. 4. The vertical mobile screen (1) on the columns (2) of the structural assembly of the information point is oriented at an angle (a) of 44 degrees, as shown in FIG. 4, this being the appropriate angle for screen-user positioning. The structural assembly that makes up the information point is sustained by the platform (4) and metal housing (5) at its base, where the air pressure elements (13) are located, anchored and hidden within said housing, which sustain and anchor the whole structure, as shown in FIG. 6.

The elements that make up the information point have very specific functions, such as the sensors, a presence sensor for detecting presence and activating the alarm or presence mechanism by sound or voice. The height sensor, which, once the person has approached the machine, measures their height and automatically situates the screen by vertical movement along the lateral guides. The mobile screen, which facilitates the regulation of its height by way of vertical (pneumatic) elements. The mobile screen is made up of two parts and physical components, a solid metal structure, within which the tactile monitor is introduced, and an injectable (recyclable) plastic one, so that the screen is separated from the tactile element, the objective of which being to reduce costs. It includes a voice computer system for the blind and other physically disabled persons who cannot operate the tactile screen. The information is controlled and depends on a network or Intranet connection, and from a central hub it can be changed or updated without need for a technician to go to each of the information points to manipulate the machines. It includes a reflecting element (mirror) on the upper part of the assembly that works as a distance visibility and information provider. It includes a system for anchoring it to the ground by way of air pressure elements attached to the metal structure, located on the rear lower area, within a metal structure to which access is gained by key or by encoded key, as a security and control system. These pressure elements work by automatic, and optionally manual, vacuum absorption.

The system of the invention constitutes a reading and printing support, although it does not have incorporated any printer or paper. The printing of documents or information is carried out in the system by UAP or UMTS (on mobile phones), so that the user can carry the information with them on their own mobile phone.

Having sufficiently disclosed the nature of the present invention, as well as the method for putting it into practice, it only remains to be added that it is possible to introduce variations, in the whole or its parts, in the shape, materials and disposal, provided that said variations do not substantially alter the characteristics of the invention that are claimed below.

1. Ergonomic thematic tourist information point, which provides users with a setup that is characterised in that in the support structure of the information point, situated in strategic positions, interactive terminals connected to a network are positioned, with all information of any kind, and with the characteristics of a “universal interface”, as well as vertical screen movement, which includes comfortable access for all sorts of people, of different height, age, and physical disability, generating an easy-to-use service for any person that comes to receive information, the computer equipment including solid state hard drives, so that the operating system is stored on chips in such a way that the activation of the system and the start of the whole operative support is carried out in real time, allowing it to store and give information as well as send messages from the information point to any other receiver, where the user can leave a message for another person or send an e-mail.

2. Ergonomic thematic tourist information point according to the first claim, characterised in that the system is provided with two sensors (Detail FIG. 2-A), a presence or alarm one, for calling the attention of people that situate themselves near the information point and within an area, measuring the electrical difference in the atmosphere, facilitating the detection of presence and the reactivation of the alarm mechanism or presence by sound or voice, where the user can approach and use the information point, the height sensor (Detail 8 FIG. 2-A), once a person has approached the support structure, facilitating measuring their height and automatically situating the screen (Detail 1 FIG. 4), with vertical movement on the lateral guides of the columns (Detail 2, FIG. 4), adjusting it to the appropriate height for the user, whether he be a person of normal height, taller, shorter, or a disabled person in a wheelchair.

3. Ergonomic thematic tourist information point according to the first claim, characterised in that the support structure where the column is rested includes a circular platform with dimensions appropriate to the computer assembly (Detail 4, FIG. 6), without steps nor barriers, facilitating approaching disabled persons.

4. Ergonomic thematic tourist information point, according to the first claim, characterised in that the mobile screen (Detail 1, FIGS. 1 and 4) is adjusted in height by vertical mobile elements (Detail 2 FIG. 4), being pneumatic elements, and which function once the height sensor has been activated, or manually, the pneumatic system optionally being substituted by an electrical system, with noise reduction, the mechanical piston being that which increases resistance and safety, the screen (Detail 1 FIGS. 1 and 4) being provided with a handle-shaped structure (Detail 3, FIGS. 1 and 2-A), on its lower area, for holding and manual pushing.

5. Ergonomic thematic tourist information point, according to the previous claim, characterised in that the mobile screen is made up of two parts and physical components, a solid metal structure into which the tactile monitor and an injectable-recyclable plastic one are introduced (Detail 11 FIG. 4), so that the screen is separated from the tactile element so that the tactile element can be replaced due to usage without replacing the screen.

6. Ergonomic thematic tourist information point, according to the first claim, characterised in that a voice system is incorporated into the assembly, adjusted to the structure of the computer point so that the blind and other physically disabled persons can use it without needing to use the tactile screen.

7. Ergonomic thematic tourist information point, according to the first claim, characterised in that all the information is controlled and depends on a network or Intranet connection, and from a central hub it can be changed or updated without the need for a technician to go to each information point to manipulate the machines.

8. Ergonomic thematic tourist information point, according to the first claim, characterised in that it includes a circular shaped reflecting-mirror element, (Detail 7, FIGS. 1, 2-B, 3 and 4), this mirror being situated on the upper part of the concave-shaped support structure, facilitating visibility and information for the users from a distance, without approaching the support structure, where information on the services can be obtained, and even if other persons are using it, as well as being an eye-catching device, since it facilitates seeing the screen from a distance.

9. Ergonomic thematic tourist information point, according to the first claim, characterised in that it is provided with a non-visible anchoring system (Detail 13, FIG. 6) for holding it to the ground by way of air pressure elements attached to the metal structure, which are located on the rear lower area, within a metal structure (Detail 5, FIG. 6), with access by key or by key and code, as a security and control system restricted to authorised technicians, the anchoring system being made up of air pressure elements, suction cups shown (Detail 13, FIG. 6), and whose functioning is carried out by way of vacuum absorption, pneumatic or manual system when electrical current is unavailable.

10. Ergonomic thematic tourist information point, according to the first claim, characterised in that the information structure has a reading and printing support within the console, the document or information printing being carried out on WAP or UMTS—on mobile phones—so that the user can take the information away on their own mobile phone.

11. Ergonomic thematic tourist information point, according to the seventh claim, characterised in that the programming base is OPC for industrial automata and robotics, thus obtaining the security in the functioning of the control and automisation systems of the machine, allowing the terminal to continue functioning with all of its characteristics if the operating system crashes, where the control automata provide complete management of the terminal.

12. Ergonomic thematic tourist information point, according to the first claim, characterised in that it includes an uninterrupted supply system connected to the computer system, managed and controlled by the computer support, the system detecting lack of power supply and automatically switching off without affecting the operating system, the system restarting itself automatically after a few seconds once the power returns
